(19) United States
(12) Patent Application Publication
(10) Pub. No.: US 2020/0165442 A1
(43) Pub. Date: May 28, 2020

(54) COMPOSITIONS CONTAINING POLYMERIC CARBODIIMIDE, EPOXIDE AND POLYESTER-BASED POLYMERS, AND PRODUCTION AND USE THEREOF

(71) Applicant: LANXESS Deutschland GmbH, Cologne (DE)

(72) Inventors: Wilhelm LAUFER, Ellerstadt (DE); Boris NEUWALD, Cologne (DE); Matthias BIENMUELLER, Krefeld (DE)

(73) Assignee: LANXESS Deutschland GmbH, Cologne (DE)

(21) Appl. No.: 16/631,583

(22) PCT Filed: Jul. 16, 2018
(86) PCT No.: PCT/EP2018/069279

§ 371 Date: Jan. 16, 2020

(30) Foreign Application Priority Data
Jul. 17, 2017 (EP) 17181680.4

(51) Int. Cl. C08L 67/02

(52) U.S. Cl. CPC C08L 67/02; C08L 2205/03

(57) ABSTRACT

The present invention relates to compositions containing halogen-free polymeric carbodiimide, halogen-free epoxide and polyester-based polymers, in particular polybutylene terephthalate-based compositions, to articles of manufacture and to their production and use.

The present invention relates to compositions containing polymeric carbodiimide, epoxide and polyester-based polymers, in particular polybutylene terephthalate-based compositions, to articles of manufacture producible therefrom and to their production and use for hydrolysis inhibition.

A very wide variety of carbodiimides have proven advantageous in many applications, for example as hydrolysis inhibitors for thermoplastics, ester-based polyols, polyurethanes, triglycerides and lubricating oils etc. However, they have the disadvantage of emitting gases possibly harmful to health and are very costly and complex to produce.

Epoxides are cheaper to produce but have the disadvantage that they do not attain the hydrolysis-stabilizing activity of carbodiimides even in very high concentrations. They act merely as acid scavengers and provide only inadequate long-term stabilization at higher temperatures. Particularly in very demanding applications under conditions such as high atmospheric humidity and temperature they fail in their activity as hydrolysis inhibitors since ester-based plastics are generally processed at temperatures above 200° C. DE 10 349 168 A1 describes a hydrolysis inhibitor composed of epoxidized fatty acid esters and glycerides and a mixture thereof with a monomeric carbodiimide. The stabilizers described therein act as acid scavengers in oils. However, under the abovementioned conditions in the processing of ester-based thermoplastics they show only inadequate, if any, activity for long-term stability to hydrolysis. Moreover, the use of monomeric carbodiimides results in increased emissions of toxic gases.

The present invention accordingly has for its object to provide novel, cost-effective compositions which are hydrolysis-resistant, cost-effective to produce and show reduced emissions. The measure of hydrolysis stability used in the context of the present invention is the measurement of tensile strength performable according to DIN EN ISO 527 after storage at 100° C. and 100% relative atmospheric humidity over a period of at least 14 days and the associated percentage change in the value determined in MPa during the measurements.

However, US 2014/0058015 A1 already describes hydrolysis-stabilized and flame retardant polybutylene terephthalate compositions and articles producible therefrom by injection molding which contain an epoxide and a carbodiimide and additionally feature exceptional heat shock resistance. The flame retardant employed is a bromine-containing epoxide compound which is not unconcerning in the case of fire due to the possible release of hydrogen bromide and which additionally has a negative effect on the melt stability of the compositions during processing.

Starting from this prior art the present invention accordingly had for its object to provide in particular hydrolysis-stabilized polybutylene terephthalate compositions for articles of manufacture which additionally feature exceptional melt stability during their processing, in particular in injection molding, wherein the polybutylene terephthalate is employed neither as a copolymer nor as a block copolymer and without additional components requiring the presence of halogen.

Melt stability describes the change in melt viscosity at elevated temperatures over time. In a non-additized polyalkylene terephthalate, melt viscosity decreases with time. However, reactive chain-extending additives, for example molecules containing two or more carbodiimide or epoxide groups, can also be used to increase melt viscosity. This is disadvantageous since the flowability of the melt decreases which can lead, inter alia, to reduced processing speeds. Furthermore, an increase in melt viscosity can lead to specks in the article of manufacture to be produced, to solidification of the injection molding material in the nozzle to be employed in injection molding or to blockages/closures in the feed system (hot runner). According to the invention molding materials having a high melt stability are therefore to be understood as meaning those that show no reduction in the flow rate determinable according to ISO 1133 (1997) even after residence times of >5 min at markedly above the melting point of the molding material to be processed at >260° C.

It has now been found that, surprisingly, the abovementioned object may be achieved when a combination of at least one polymeric aromatic carbodiimide, at least one epoxide having at least 2 epoxide groups and at least one polyester-based polymer, in particular a polyalkylene terephthalate or polylactide, is employed.

In respect of polybutylene terephthalate (PBT) the additional object of melt stability is also achieved through the use of both halogen-free epoxide and halogen-free polymeric aromatic carbodiimide, wherein the PBT is employed neither as a copolymer nor as a block polymer.

The present invention accordingly provides compositions containing
(a) at least one polymeric aromatic carbodiimide of formula (I)

R¹-R²—(—N═C═N—R²—)ₘ—R¹ (I),
in which
m represents an integer in the range from 2 to 500, preferably in the range from 3 to 20, very particularly preferably in the range from 4 to 10,
R² represents C₁-C₁₂-alkyl-substituted arylenes, C₇-C₁₈-alkylaryl-substituted arylenes and optionally C₁-C₁₂-alkyl-substituted C₁-C₈-alkylene-bridged arylenes comprising a total of 7 to 30 carbon atoms and arylene, preferably

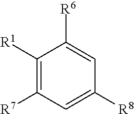

R⁶, R⁷ and R⁸ each independently of one another represent methyl or ethyl, wherein each benzene ring bears only one methyl group and n represents an integer in the range from 1 to 10,
and
R¹ represents a radical from the group of —NCO, —NCNR³—NHCONHR³, —NHCONR³R⁴ or —NHCOOR⁵,
wherein R³ and R⁴ are identical or different and represent a C₁-C₁₂-alkyl, C₆-C₁₂-cycloalkyl, C₇-C₁₈-aralkyl or aryl radical and R⁵ represents a radical from the group of C₁-C₂₂-alkyl-, C₆-C₁₂-cycloalkyl-, C₆-C₁₈-aryl or C₇-C₁₈-aralkyl and an unsaturated alkyl radical having 2-22 carbon atoms or an alkoxypolyoxyalkylene radical,
(b) at least one epoxide, preferably having at least 2 epoxide groups, and
(c) at least one thermoplastic polyester-based polymer.

The invention preferably relates to compositions containing
(a) at least one halogen-free polymeric aromatic carbodiimide of formula (I)

R¹-R²—(—N═C═N—R²—)ₘ—R¹ (I),
in which
m represents an integer from 2 to 500, preferably 3 to 20, very particularly preferably 4 to 10,
R² represents C₁-C₁₂-alkyl-substituted arylenes, C₇-C₁₈-alkylaryl-substituted arylenes and optionally C₁-C₁₂-alkyl-substituted C₁-C₈-alkylene-bridged arylenes comprising a total of 7 to 30 carbon atoms and arylene, preferably

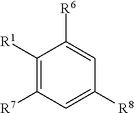

in which R⁶, R⁷ and R⁸ each independently of one another represent methyl or ethyl, wherein each benzene ring bears only one methyl group and n represents an integer in the range from 1 to 10
and
R¹ represents a radical from the group of —NCO, —NCNR³—NHCONHR³, —NHCONR³R⁴ or —NHCOOR⁵,
wherein R³ and R⁴ are identical or different and in each case independently represent a radical from the group of C₁-C₁₂-alkyl, C₆-C₁₂-cycloalkyl, C₇-C₁₈-aralkyl or aryl radical and R⁵ represents a radical from the group of C₁-C₂₂-alkyl, C₆-C₁₂-cycloalkyl, C₆-C₁₈-aryl or C₇-C₁₈-aralkyl and an unsaturated alkyl radical having 2-22 carbon atoms or an alkoxypolyoxyalkylene radical,
(b) at least one halogen-free epoxide, preferably a halogen-free epoxide having at least 2 epoxide groups and
(c) polybutylene terephthalate, with the proviso that (c) the polybutylene terephthalate (PBT) is present neither as a block polymer nor as a copolymer.

The term arylene here comprises in particular phenylene, naphthylene, anthrylene and/or phenanthrylene radicals, preferably phenylene radicals.

Component (a)

The halogen-free polymeric aromatic carbodiimides of the component (a) are preferably compounds of formula (II),

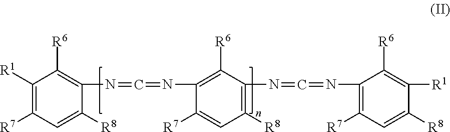

where R¹ is selected from the group of —NCO, —NHCONHR³, —NHCONR³R⁴ or —NHCOOR⁵,
wherein R³ and R⁴ are identical or different and represent a C₁-C₁₂-alkyl, C₆-C₁₂-cycloalkyl, C₇-C₁₅-aralkyl radical or aryl radical,
R⁵ represents a C₁-C₂₂-alkyl, C₆-C₁₂-cycloalkyl, C₆-C₁₅-aryl or C₇-C₁₅-aralkyl radical and an unsaturated alkyl radical having 2-22 carbon atoms, preferably 12-20 carbon atoms, particularly preferably 16-18 carbon atoms, or an alkoxypolyoxyalkylene radical and
R⁶, R⁷ and R⁸ each independently of one another represent methyl or ethyl, wherein each benzene ring bears only one methyl group and n=1 to 10.

The carbodiimide content (NCN content measured by titration with oxalic acid) of the halogen-free carbodiimides of formula (II) employable as component (a) according to the invention is preferably 2-14% by weight, preferably 4-13% by weight, particularly preferably 6-12% by weight, based on 100% by weight of the respective carbodiimide employable as component (a).

The halogen-free carbodiimides of formula (II) employable as component (a) according to the invention furthermore preferably have an average molar mass (Mw) determinable by GPC viscometry in the range from 1000 to 5000 g/mol, particularly preferably in the range from 1500 to 4000 g/mol, very particularly preferably in the range from 2000 to 3000 g/mol.

Physical, mechanical and rheological properties are often determined by polymolecularity (the ratio of weight-average molecular weight to number-average molecular weight).

This ratio is also known as polydispersity and is a measure for the width of a molar mass distribution (MMD). It is preferable according to the invention when halogen-free carbodiimides of formula (II) employable as component (a) have a polydispersity D=Mw/Mn determinable by gel permeation chromatography (GPC) in the range from 1.2 to 2.2, particularly preferably in the range from 1.4 to 1.8.

The halogen-free carbodiimides employable as component (a) according to the invention are preferably commercially available compounds, in particular polymeric carbodiimides marketed under the name Stabaxol® by Lanxess Deutschland GmbH. However, they are also producible by the processes described in EP 3 018 124 A1.

Component (b)

It is preferable when the halogen-free component (b) comprises altogether at least two epoxide groups per molecule, it being preferable when at least one epoxide group is terminal.

Production of the halogen-free epoxidized compounds employable as component (b) is likewise known to those skilled in the art. Preferred halogen-free epoxidized compounds are polyglycidyl or poly(beta-methylglycidyl) ethers, preferably obtainable by reaction of a compound having at least two free alcoholic or phenolic hydroxyl groups and/or by reaction of phenolic hydroxyl groups with a substituted epichlorohydrin.

Preferred polyglycidyl or poly(beta-methylglycidyl) ethers derive from acyclic alcohols, in particular ethylene glycol, diethylene glycol and higher poly(oxyethylene) glycols, propane-1,2-diol or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylpropane, bistrimethylolpropane, pentaerythritol, sorbitol, and from polyepichlorohydrins.

Alternatively preferred polyglycidyl or poly(beta-methylglycidyl) ethers derive from cycloaliphatic alcohols, in particular 1,3- or 1,4-dihydroxycyclohexane, bis(4-hydroxycyclohexyl)methane, 2,2-bis(4-hydroxycyclohexyl)propane or 1,1-bis(hydroxymethyl)cyclohex-3-ene, or they comprise aromatic nuclei based on N,N-bis(8, 2-hydroxyethyl)aniline or p,p′-bis(2-hydroxyethylamino)diphenylmethane.

Preferred epoxidized compounds are also based on mononuclear phenols or on polynuclear phenols. Preferred mononuclear phenols are resorcinol or hydroquinone. Preferred polynuclear phenols are bis(4-hydroxyphenyl)methane, 2,2-bis(4-hydroxyphenyl)propane, 2,2-bis(3,5-dibromo-4-hydroxyphenyl)propane or 4,4′-dihydroxydiphenylsulfone.

Preferred condensation products of phenols with formaldehyde are phenol novolacs.

Preferred aromatic epoxy compounds have 2 terminal epoxy functions.

A halogen-free aromatic epoxide compound having 2 terminal epoxide functions preferably employable as component (b) according to the invention is an oligomeric reaction product of bisphenol A with epichlorohydrin having an average molecular weight determinable according to EN ISO 10927 in the range from 900 to 1200 g/mol and an epoxy index determinable according to ISO 3001 in the range from 450 to 600 grams per equivalent. It is particularly preferable to employ as component (b) a halogen-free oligomeric reaction product of formula (III) from the reaction of bisphenol A with epichlorohydrin,

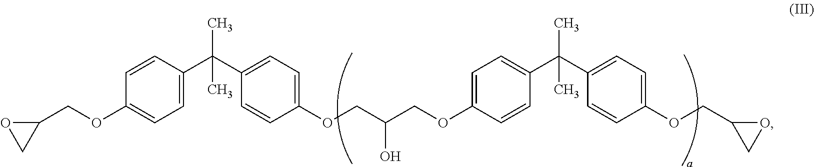

in which a represents an integer in the range from 0 to 10, preferably in which a represents an integer in the range from 1 to 8, particularly preferably in which a represents an integer in the range from 1 to 6, very particularly preferably in which a represents an integer in the range from 2 to 3, wherein a represents the average number.

The halogen-free epoxides employable as component (b) are preferably produced by a process according to US2002/0128428 A1 and then have an average molecular weight according to EN ISO 10927 in the range from 900 to 1200 g/mol which in formula (III) corresponds to an a in the range from 2 to 3 with an epoxy index determinable according to ISO 3001 in the range from 450 to 600 grams per equivalent.

An epoxide compound employable as component (b) according to the invention preferably has a Mettler softening point determinable according to DIN 51920 in the range from 0° C. to 150° C., particularly preferably in the range from 50° C. to 120° C., very particularly preferably in the range from 60° C. to 110° C. and in particular in the range from 75° C. to 95° C. The Mettler softening point is the temperature at which the sample flows out of a cylindrical nipple having an outflow opening of 6.35 mm in diameter, thus interrupting a light gate which lies 19 mm below. To this end, the sample is heated in air under constant conditions.

Epoxide compounds preferably employable as component (b) have an average epoxide equivalent weight (EEW), grams of resin containing one mole of epoxidically bonded oxygen, determinable by titration according to DIN 16945 in the range from 160 to 2000 g/eq, preferably in the range from 250 to 1200 g/eq, particularly preferably in the range from 350 to 1000 g/eq and especially preferably in the range from 450 bis 800 g/eq.

Especially preferably employed as component b) is a poly(bisphenol A-co-epichlorohydrin) [CAS No. 25068-38-6] preferably having a number average molecular weight (Mₙ) determinable by MALDI-TOF mass spectrometry by matrix-assisted laser desorption/ionization time-of-flight mass spectrometry according to EN ISO 10927 in the range from 600 to 1800 g/mol, obtainable for example as Epilox® from Leuna Harze GmbH, Leuna.

Further preferred epoxide compounds having at least 2 epoxide functions are compounds from the group of epoxides commercially available under the name Joncryl® from BASF AG, in particular Joncryl® 4368, which contain the following units in any combination

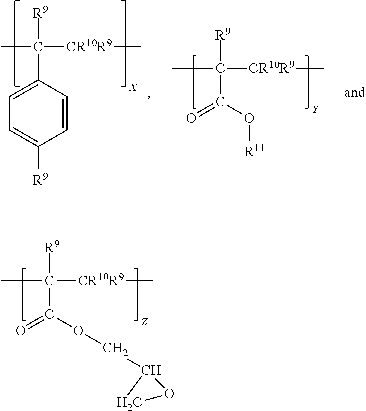

In the units shown R⁹, R¹⁰ each independently of one another represent H or C₁-C₈-alkyl, R¹¹ represents C₁-C₈-alkyl, x and y independently of one another represent an integer in the range from 1 to 20, and z represents an integer in the range from 2 to 20. The chain terminus is formed by end groups R* which independently of one another represent H or C₁-C₈-alkyl.

It is preferable when a halogen-free epoxide employable as component (b) corresponds to formula (IV)

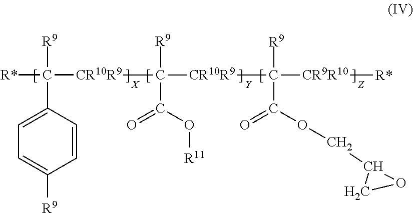

in which R⁹, R¹⁰ each independently of one another represent H or C₁-C₈-alkyl, R¹¹ represents C₁-C₈-alkyl, x and y independently of one another represent an integer in the range from 1 to 20 and z represents an integer in the range from 2 to 20, wherein the end groups R* independently of one another represent H or C₁-C₈-alkyl.

In a preferred or alternative embodiment epoxidized fatty acid esters of glycerol, in particular epoxidized vegetable oils, are employed as component (b). These are obtained by epoxidation of the reactive olefin groups of triglycerides of unsaturated fatty acids. Epoxidized fatty acid esters of glycerol may be produced starting from unsaturated fatty acid esters of glycerol, preferably from vegetable oils, and organic peroxycarboxylic acids (Prilezhaev reaction). Processes for producing epoxidized vegetable oils are described for example in Smith, March, March's Advanced Organic Chemistry, 5^{th} edition, Wiley-Interscience, New York, 2001. Preferred epoxidized fatty acid esters of glycerol are vegetable oils. An epoxidized fatty acid ester of glycerol particularly preferably employable as component (b) according to the invention is epoxidized soybean oil [CAS No. 8013-07-8].

In a further preferred or alternative embodiment epoxy-functional comonomers based on glycidyl methacrylate-modified styrene acrylate polymers obtainable by polymerization of styrene, glycidy methacrylate and acrylic acid and/or methacrylic acid according to DE 10 316 615 A1 are employed as component (b).

Component (c)

The thermoplastic polyester-based polymers c) are poly-C₁-C₈-alkylene terephthalates, particularly preferably polyethylene terephthalate (PET), polytrimethylene terephthalate (PTT), and copolyesters, thermoplastic polyester elastomers (TPE E), ethylene vinyl acetate (EVA), polylactic acid (PLA) and/or PLA derivatives, polybutylene succinates (PBS), polyhydroxyalkanoates (PHA) and various blends thereof. Polylactides (PLA) are preferred.

In a preferred embodiment of the present invention the composition according to the invention contains
a) 0.2% to 2% by weight, preferably 0.4% to 1.5% by weight, particularly preferably 0.5% to 1.0% by weight;
b) 0.05% to 4% by weight, preferably 0.1% to 2% by weight, particularly preferably 0.5% to 1.5% by weight;
c) 94% to 99.75% by weight, preferably 96.5 to 99.5% by weight, particularly preferably 97.5 to 99.0% by weight.

Especially preferred according to the invention is polybutylene terephthalate (PBT) [CAS No. 24968-12-5] which according to the invention is employed neither as a copolymer nor as a block polymer and is available under the trade name Pocan® from Lanxess Deutschland GmbH, Cologne.

The PBT employable as component (c) preferably has an intrinsic viscosity in the range from 30 to 150 cm³/g, particularly preferably in the range from 40 to 130 cm³/g, very particularly preferably in the range from 50 to 100 cm³/g in each case measured in phenol/o-dichlorobenzene (1:1 parts by weight) at 25° C. Intrinsic viscosity iV also known as the Staudinger Index or limiting viscosity is proportional to the average molecular mass according to the Mark-Houwink equation and is the extrapolation of the viscosity number VN for the case of vanishing polymer concentrations. It can be estimated from series of measurements or through the use of suitable approximation methods (e.g. Billmeyer). The VN [ml/g] is obtained from measurement of the solution viscosity in a capillary viscometer, preferably an Ubbelohde viscometer. The solution viscosity is a measure of the average molecular weight of a plastic. The determination is effected on dissolved polymer using various solvents, preferably formic acid, m-cresol, tetrachloroethane, phenol, 1,2-dichlorobenzene, and concentrations. The viscosity number VN makes it possible to monitor the processing and performance characteristics of plastics.

It is preferable when the components (a), (b) and (c) are employed in such a way that per 100 parts by mass of the PBT employable as component (c) 0.1 to 5 parts by mass of the component (a) and 0.1 to 10 parts by mass of the component (b) are employed.

Component (d)

In a preferred embodiment compositions according to the invention and articles of manufacture producible therefrom also contain in addition to the components (a), (b) and (c) at least one component (d), an additive distinct from (a), (b) and (c). The component (d) is preferably employed in amounts in the range from 0.1 to 30 parts by mass based on 100 parts by mass of the component (c), the PBT.

Preferred additives of component (d) are lubricants and demolding agents, UV stabilizers, colorants, chain-extending additives, plasticizers, flow promoters, heat stabilizers, antioxidants, gamma-ray stabilizers, hydrolysis stabilizers, elastomer modifiers, antistats, emulsifiers, nucleating agents, processing aids, antidrip agents, flame retardants and fillers and reinforcers.

The additives of the component (d) may be used alone or in admixture/in the form of masterbatches.

It is preferable to use halogen-free additives for the reasons mentioned above.

Lubricants and demolding agents are selected from at least one of the group of long-chain fatty acids, salts of long-chain fatty acids, ester derivatives of long-chain fatty acids and montan waxes.

Preferred long-chain fatty acids are stearic acid or behenic acid. Preferred salts of the long-chain fatty acids are calcium or zinc stearate. Preferred ester derivatives of long-chain fatty acids are those based on pentaerythritol, more particularly C₁₆-C₁₈ fatty acid esters of pentaerythritol [CAS No. 68604-44-4] or [CAS No. 85116-93-4].

Montan waxes in the context of the present invention are mixtures of straight-chain saturated carboxylic acids having chain lengths of from 28 to 32 carbon atoms. It is particularly preferable in accordance with the invention to employ lubricants and/or mold-release agents from the group of esters of saturated or unsaturated aliphatic carboxylic acids having 8 to 40 carbon atoms with aliphatic saturated alcohols having 2 to 40 carbon atoms and metal salts of saturated or unsaturated aliphatic carboxylic acids having 8 to 40 carbon atoms, wherein pentaerythritol tetrastearate, calcium stearate [CAS No. 1592-23-0] and/or ethylene glycol dimontanate, here in particular Licowax® E [CAS No. 74388-22-0] from Clariant, Muttenz, Basle, are very particularly preferred and pentaerythritol tetrastearate [CAS No. 115-83-3], for example available as Loxiol® P861 from Emery Oleochemicals GmbH, Dusseldorf, Germany, is especially very particularly preferred.

Preferably employed as UV stabilizers are substituted resorcinols, salicylates, benzotriazoles, triazine derivatives or benzophenones.

Preferably employed as colorants are organic pigments, preferably phthalocyanines, quinacridones, perylenes, and dyes, preferably nigrosin or anthraquinones, also inorganic pigments, in particular titanium dioxide (if not already used as filler), ultramarine blue, iron oxide, zinc sulphide or carbon black.

Suitable as the titanium dioxide preferably employable according to the invention as pigment are titanium dioxide pigments whose parent oxides can be produced by the sulfate (SP) or chloride (CP) process and have an anatase and/or rutile structure, preferably a rutile structure. The parent oxide need not be stabilized but a specific stabilization is preferred: for the CP parent oxide by Al doping of 0.3-3.0% by weight (calculated as Al₂O₃) and an oxygen excess in the gas phase during the oxidation of the titanium tetrachloride to titanium dioxide of at least 2%; for the SP parent oxide by doping for example with Al, Sb, Nb or Zn. Particular preference is given to “light” stabilization with Al, or in the case of higher amounts of Al doping to compensation with antimony. It is known that when using titanium dioxide as white pigment in paints and coatings, plastics materials etc. unwanted photocatalytic reactions caused by UV absorption lead to decomposition of the pigmented material. This involves absorption of light in the near ultraviolet range by titanium dioxide pigments, thus forming electron-hole pairs which produce highly reactive free radicals on the titanium dioxide surface. The free radicals formed result in binder decomposition in organic media. It is preferable according to the invention to reduce the photoactivity of the titanium dioxide by inorganic aftertreatment thereof, particularly preferably with oxides of Si and/or Al and/or Zr and/or through the use of Sn compounds.

It is preferable when the surface of pigmentary titanium dioxide has a covering of amorphous precipitated oxide hydrates of the compounds SiO₂ and/or Al₂O₃ and/or zirconium oxide. The Al₂O₃ shell facilitates pigment dispersion into the polymer matrix; the SiO₂ shell makes it more difficult for charge exchange to take place at the pigment surface, thus preventing polymer degradation.

According to the invention the titanium dioxide is preferably provided with hydrophilic and/or hydrophobic organic coatings, in particular with siloxanes or polyalcohols.

Titanium dioxide [CAS No. 13463-67-7] preferably employable according to the invention as a colorant of component (d) preferably has an average particle size d50 in the range from 90 nm to 2000 nm, particularly preferably in the range from 200 nm to 800 nm. The average particle size d50 is the value determined from the particle size distribution at which 50% by weight of the particles have an equivalent sphere diameter smaller than this d50 value. The relevant standard is ISO 13317-3.

The reported values for particle size distribution and average particle size for titanium dioxide are based on so-called surface-based particle sizes, in each case before incorporation into the thermoplastic molding material. Particle size determination is performed in accordance with the invention by laser diffractometry, see C. M. Keck, Moderne Pharmazeutische Technologie 2009, Freie Universität Berlin, Chapter 3.1. or QUANTACHROME PARTIKELWELT NO 6, June 2007, pages 1 to 16.

Examples of commercially available titanium dioxide include Kronos® 2230, Kronos® 2233, Kronos® 2225 and Kronos® vlp7000 from Kronos, Dallas, USA.

The titanium dioxide employable as pigment is preferably employed in amounts in the range from 0.1 to 60 parts by mass, particularly preferably in amounts in the range from 1 to 35 parts by mass, very particularly preferably in amounts in the range from 2 to 20 parts by mass, in each case based on 100 parts by mass of the component (c).

Plasticizers preferably employable as component (D) are dioctyl phthalate, dibenzyl phthalate, butyl benzyl phthalate, hydrocarbon oils or N-(n-butyl)benzenesulfonamide.

Flow promoters preferably employable as component (d) are copolymers containing at least one α-olefin with at least one methacrylic ester or acrylic ester of an aliphatic alcohol. Copolymers of at least one α-olefin with at least one methacrylic ester or acrylic ester of an aliphatic alcohol are particularly preferred. Copolymers of an α-olefin and an acrylic ester of an aliphatic alcohol are very particularly preferred. Copolymers where the α-olefin is formed from ethene and/or propene and the methacrylic ester or acrylic ester contains as its alcohol component linear or branched alkyl groups having 6 to 20 carbon atoms are especially preferred. A copolymer of ethene and 2-ethylhexyl acrylate is especially very particularly preferred. Copolymers suitable as flow promoters according to the invention are characterized not only by their composition but also by their low molecular weight. Correspondingly, preference is given especially to copolymers having an MFI measured at 190° C. and a loading of 2.16 kg of at least 100 g/10 min, preferably of at least 150 g/10 min, particularly preferably of at least 300 g/10 min. The MFI, melt flow index, characterizes the flow of a melt of a thermoplastic and is subject to the standards ISO 1133 or ASTM D 1238. The MFI, and all figures relating to the MFI in the context of the present invention, relate or were measured or determined in a standard manner according to ISO 1133 at 190° C. with a test weight of 2.16 kg.

Elastomer modifiers preferably employable as component (d) comprise inter alia one or more graft polymers of

D.1 5% to 95% by weight, preferably 30% to 90% by weight, of at least one vinyl monomer on

D.2 95% to 5% by weight, preferably 70% to 10% by weight, of one or more graft substrates having glass transition temperatures <10° C., preferably <0° C., particularly preferably <−20° C. The weight percentages are in this case based on 100% by weight of the elastomer modifier employable as component (d).

The graft substrate D.2 generally has an average particle size (d50) in the range from 0.05 to 10 μm, preferably in the range from 0.1 to 5 μm, particularly preferably in the range from 0.2 to 1 μm.

Monomers D.1 are preferably mixtures of

D.1.1 50% to 99% by weight of vinylaromatics and/or ring-substituted vinylaromatics, in particular styrene, α-methylstyrene, p-methylstyrene, p-chlorostyrene, and/or (C₁-C₈-alkyl methacrylates, in particular methyl methacrylate, ethyl methacrylate, and

D.1.2 1% to 50% by weight of vinyl cyanides, in particular unsaturated nitriles such as acrylonitrile and methacrylonitrile, and/or (C₁-C₈-alkyl (meth)acrylates, in particular methyl methacrylate, glycidyl methacrylate, n-butyl acrylate, t-butyl acrylate, and/or derivatives, in particular anhydrides and imides of unsaturated carboxylic acids, in particular maleic anhydride or N-phenylmaleimide. The percentages by weight are in this case based on 100% by weight of the elastomer modifier employable as component (d).

Preferred monomers D.1.1 are selected from at least one of the monomers styrene, α-methylstyrene and methyl methacrylate; preferred monomers D.1.2 are selected from at least one of the monomers acrylonitrile, maleic anhydride, glycidyl methacrylate and methyl methacrylate.

Particularly preferred monomers are D.1.1 styrene and D.1.2 acrylonitrile.

Graft substrates D.2 suitable for the graft polymers employable in the elastomer modifiers are, for example, diene rubbers, EPDM rubbers, i.e. those based on ethylene/propylene and optionally diene, also acrylate, polyurethane, silicone, chloroprene and ethylene/vinyl acetate rubbers. EPDM stands for ethylene-propylene-diene rubber.

Preferred graft substrates D.2 are diene rubbers, especially based on butadiene, isoprene, etc., or mixtures of diene rubbers or copolymers of diene rubbers or mixtures thereof with further copolymerizable monomers, especially as per D.1.1 and D.1.2, with the proviso that the glass transition temperature of component D.2 is <10° C., preferably <0° C., more preferably <−10° C.

Particularly preferred graft substrates D.2 are ABS polymers (emulsion, bulk and suspension ABS), wherein ABS stands for acrylonitrile-butadiene-styrene, as described, for example, in DE-A 2 035 390 or in DE-A 2 248 242 or in Ullmann, Enzyklopädie der Technischen Chemie, vol. 19 (1980), p. 277-290.

The elastomer modifiers/graft polymers are produced by free-radical polymerization, preferably by emulsion, suspension, solution or bulk polymerization, in particular by emulsion or bulk polymerization.

Particularly suitable graft rubbers also include ABS polymers, which are produced by redox initiation with an initiator system composed of organic hydroperoxide and ascorbic acid according to U.S. Pat. No. 4,937,285.

Since, as is well known, the graft monomers are not necessarily fully grafted onto the graft substrate in the grafting reaction, “graft polymers” is according to the invention also to be understood as meaning products produced by (co)polymerization of the graft monomers in the presence of the graft substrate and co-obtained in the workup.

Likewise suitable acrylate rubbers are based on graft substrates D.2 which are preferably polymers of alkyl acrylates, optionally with up to 40% by weight, based on H.2, of other polymerizable, ethylenically unsaturated monomers. Preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, preferably chloroethyl acrylate, glycidyl esters, and mixtures of these monomers. Particularly preferred in this context are graft polymers having butyl acrylate as the core and methyl methacrylates as the shell, in particular Paraloid® EXL2300, Dow Corning Corporation, Midland Mich., USA.

Further preferably suitable graft substrates according to D.2 are silicone rubbers having graft-active sites, as are described in DE-A 3 704 657, DE-A 3 704 655, DE-A 3 631 540 and DE-A 3 631 539.

Preferred graft polymers comprising a silicone proportion are those comprising methyl methacrylate or styrene-acrylonitrile as the shell and a silicone/acrylate graft as the core. Employable graft polymers having styrene-acrylonitrile as the shell include Metablen® SRK200 for example. Employable graft polymers having methyl methacrylate as the shell include Metablen® S2001, Metablen® S2030 and/or Metablen® SX-005, for example. It is particularly preferable to employ Metablen® S2001. The products having the trade name Metablen® are available from Mitsubishi Rayon Co., Ltd., Tokyo, Japan.

Crosslinking may be achieved by copolymerizing monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes; but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5% by weight, in particular 0.05% to 2% by weight, based on 100% by weight of the graft substrate D.2.

For cyclic crosslinking monomers having at least 3 ethylenically unsaturated groups it is advantageous to restrict the amount to below 1% by weight based on 100% by weight of the graft substrate D.2.

Preferred “other” polymerizable, ethylenically unsaturated monomers which, in addition to the acrylic esters, may optionally be used to produce the graft substrate D.2 are acrylonitrile, styrene, α-methylstyrene, acrylamides, vinyl C₁-C₆-alkyl ethers, methyl methacrylate, glycidyl methacrylate, butadiene. Preferred acrylate rubbers used as graft substrate D.2 are emulsion polymers having a gel content of at least 60% by weight.

As well as elastomer modifiers based on graft polymers it is likewise possible to use elastomer modifiers which are not based on graft polymers and have glass transition temperatures of <10° C., preferably <0° C., particularly preferably <−20° C. These preferably include elastomers having a block copolymer structure and additionally thermoplastically meltable elastomers, in particular EPM, EPDM and/or SEBS rubbers (EPM=ethylene-propylene copolymer, EPDM=ethylene-propylene-diene rubber and SEBS=styrene-ethene-butene-styrene copolymer).

Preferred flame retardants employable as component (d) are halogen-free.

The further phosphorus-containing flame retardants preferably employable as component (d) include for example phosphorus compounds from the group of inorganic metal phosphinates, especially aluminum phosphinate and zinc phosphinate, of mono- and oligomeric phosphoric and phosphonic esters, especially triphenyl phosphate (TPP), resorcinol bis(diphenylphosphate) (RDP), bisphenol A bis(diphenylphosphate) (BDP) including oligomers, polyphosphonates, especially bisphenol A-diphenyl methylphosphonate copolymers, for example Nofia™ HM1100 [CAS No. 68664-06-2] from FRX Polymers, Chelmsford, USA), and also derivatives of the 9,10-dihydro-9-oxa-10-phosphaphenanthrene 10-oxides (DOPO derivatives), phosphonate amines, metal phosphonates, especially aluminum phosphonate and zinc phosphonate, phosphine oxides and phosphazenes. Particularly preferred phosphazenes are phenoxyphosphazene oligomers. The phosphazenes and production thereof are described for example in EP-A 728 811, DE-A 1961668 and WO-A 97/40092. Particularly preferably employed according to the invention are cyclic phenoxyphosphazenes such as 2,2,4,4,6,6-hexahydro-2,2,4,4,6,6-hexaphenoxytriazatriphosphorines [CAS No. 1184-10-7] and/or those as obtainable for example from Fushimi Pharmaceutical Co. Ltd, Kagawa, Japan under the name Rabitle® FP110 [CAS No. 1203646-63-2].

Likewise employable as flame retardants of the component (d) are nitrogen-containing flame retardants, individually or in admixture.

Preference is given to guanidine salts, especially guanidine carbonate, primary guanidine cyanurate, primary guanidine phosphate, secondary guanidine phosphate, primary guanidine sulfate, secondary guanidine sulfate, guanidine pentaerythrityl borate, guanidine neopentyl glycol borate, urea phosphate and urea cyanurate. Also employable are reaction products of melem, melam and melon with condensed phosphoric acids. Likewise suitable are tris(hydroxyethyl)isocyanurate or reaction products thereof with carboxylic acids, benzoguanamine and adducts and salts thereof and also products thereof that are substituted on the nitrogen as well as their salts and adducts. Suitable further nitrogen-containing components include allantoin compounds and also salts thereof with phosphoric acid, boric acid or pyrophosphoric acid, and also glycolurils or salts thereof. Further preferred nitrogen-containing flame retardants are the reaction products of trichlorotriazine, piperazine and morpholine having CAS No. 1078142-02-5, in particular MCA PPM Triazin HF from MCA Technologies GmbH, Biel-Benken, Switzerland.

Other flame retardants or flame retardant synergists not specifically mentioned here may also be employed as component d). These also include purely inorganic phosphorus compounds, in particular red phosphorus or boron phosphate hydrate. It is also possible to employ mineral flame retardant additives or salts of aliphatic and aromatic sulfonic acids, in particular metal salts of 1-perfluorobutanesulfonic acid. Also suitable are flame retardant synergists from the group of the oxygen-, nitrogen- or sulfur-containing metal compounds wherein metal is antimony, zinc, molybdenum, calcium, titanium, magnesium or boron, preferably antimony trioxide, antimony pentoxide, sodium antimonate, zinc oxide, zinc borate, zinc stannate, zinc hydroxystannate, zinc sulfide, molybdenum oxide, and, if not already used as colorant, titanium dioxide, magnesium carbonate, calcium carbonate, calcium oxide, titanium nitride, boron nitride, magnesium nitride, zinc nitride, calcium borate, magnesium borate or mixtures thereof.

Further suitable flame retardant additives preferably employable as component (d) are char formers, particularly preferably poly(2,6-diphenyl-1,4-phenyl) ether, especially poly(2,6-dimethyl-1,4-phenylene) ether [CAS No. 25134-01-4], phenol-formaldehyde resins, polycarbonates, polyimides, polysulfones, polyethersulfones or polyether ketones, and also antidrip agents, especially tetrafluoroethylene polymers. The tetrafluoroethylene polymers may be employed in pure form or else in combination with other resins, preferably styrene-acrylonitrile (SAN), or acrylates, preferably methyl methacrylate/butyl acrylate. An especially preferably suitable example of tetrafluoroethylene-styrene-acrylonitrile resins is, for example, Cycolac® INP 449 [CAS No. 1427364-85-9] from Sabic Corp., Riyadh, Saudi Arabia; an especially preferably suitable example of tetrafluoroethylene-acrylate resins is, for example, Metablen A3800 [CAS No. 639808-21-2] from Mitsubishi Rayon Co., Ltd., Tokyo, Japan. Antidrip agents containing tetrafluoroethylene polymers are used according to the invention as component (d) preferably in amounts in the range from 0.01 to 5 parts by mass, particularly preferably in the range from 0.05 to 2 parts by mass, in each case based on 100 parts by mass of component c).

In one embodiment of the present invention it is also possible to employ halogenated flame retardants as component (d) if required in the application. These include commercially available organic halogen compounds with or without synergists. Halogenated, in particular brominated and chlorinated, compounds preferably include ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene and brominated polyphenylene ethers.

The flame retardants additionally employable as component (d) may be added to the polyalkylene terephthalate or polycycloalkylene terephthalate in pure form or else via masterbatches or compactates.

Heat stabilizers preferably employeable as component (d) are selected from the group of sulfur-containing stabilizers, especially sulfides, dialkylthiocarbamates or thiodipropionic acids, and also those selected from the group of the iron salts and the copper salts, in the latter case especially copper(I) iodide, being used preferably in combination with potassium iodide and/or sodium hypophosphite NaH₂PO₂, and also sterically hindered amines, especially tetramethylpiperidine derivatives, aromatic secondary amines, especially diphenylamines, hydroquinones, substituted resorcinols, salicylates, benzotriazoles and benzophenones, and also sterically hindered phenols and aliphatically or aromatically substituted phosphites, and also differently substituted representatives of these groups.

Among the sterically hindered phenols preference is given to employing those having at least one 3-tert-butyl-4-hydroxy-5-methylphenyl building block and/or at least one 3,5-di(tert-butyl-4-hydroxyphenyl) building block, particular preference being given to 1,6-hexanediol bis[3-(3,5-di-tert-butyl-4-hydroxyphenyl)propionate] [CAS No. 35074-77-2] (Irganox® 259 from BASF SE, Ludwigshafen, Germany), pentaerythritol tetrakis[3-(3,5-di-tert-butyl-4-hydroxyphenyl)propionate] [CAS No. 6683-19-8] (Irganox® 1010 from BASF SE) and 3,9-bis[2-[3-(3-tert-butyl-4-hydroxy-5-methylphenyl)propionyloxy]-1,1-dimethylethyl]-2,4,8,10-tetraoxaspiro[5.5]undecanes [CAS No. 90498-90-1] (ADK Stab® AO 80). ADK Stab® AO 80 is commercially available from Adeka-Palmerole SAS, Mulhouse, France.

Among the aliphatically or aromatically substituted phosphites, preference is given to employing bis(2,4-dicumylphenyl)pentaerythritol diphosphite [CAS No. 154862-43-8], which is available for example from Dover Chemical Corp., Dover, USA under the trade name Doverphos® S9228, and tetrakis(2,4-di-tert-butylphenyl)-1,1-biphenyl-4,4′-diyl bisphosphonite [CAS No. 38613-77-3], which is obtainable, for example, as Hostanox® P-EPQ from Clariant International Ltd., Muttenz, Switzerland.

In a further embodiment of the present invention the composition contains as component (d) in addition to the components (a), (b) and (c) at least one filler or reinforcer, preferably a filler or reinforcer in the form of fibers, in particular glass fibers. According to “http://de.wikipedia.org/wiki/Faser-Kunststoff-Verbund”, a distinction is made between chopped fibers, also known as short fibers, having a length in the range from 0.1 to 1 mm, long fibers having a length in the range from 1 to 50 mm and continuous fibers having a length L>50 mm. Short fibers are used in the injection molding industry and can be processed directly using an extruder. Long fibers can likewise still be processed in extruders. They are widely used in fiber spraying. Long fibers are often added to thermosets as a filler. Endless fibers are used in fiber-reinforced plastics in the form of rovings or fabric. Products comprising continuous fibers achieve the highest stiffness and strength values. Also available are ground glass fibers, the length of these after grinding typically being in the range from 70 to 200 μm.

It is preferable according to the invention to employ as component (d) chopped long glass fibers having a starting length in the range from 1 to 50 mm, particularly preferably in the range from 1 to 10 mm, very particularly preferably in the range from 2 to 7 mm. The starting length describes the average length of the glass fibers prior to compounding of the composition(s) according to the invention to afford a molding material according to the invention. The fibers, preferably glass fibers, employable as component (d) may as a consequence of processing, in particular compounding, to afford the molding material or to afford the article of manufacture in the molding material or in the article of manufacture have a d97 and/or d50 smaller than the originally employed fibers or glass fibers. Thus, the arithmetic average of the fiber length/glass fiber length after processing is frequently only in the range from 150 μm to 300 μm.

In the context of the present invention the fiber length and fiber length distribution/glass fiber length and glass fiber length distribution are in the case of processed fibers/glass fibers determined according to ISO 22314 which provides for intially ashing the samples at 625° C. Subsequently, the ash is placed onto a microscope slide covered with demineralized water in a suitable crystallizing dish and the ash is distributed in an ultrasound bath without action of mechanical forces. The next step comprises drying in an oven at 130° C. followed by determination of glass fiber length with the aid of optical microscopy images. To this end at least 100 glass fibers are measured in each of three images and a total of 300 glass fibers are therefore used to determine the length. The glass fiber length can be calculated either as the arithmetic average Iₙ according to the equation

$${l}_{n} = \frac{1}{n} \cdot {\sum }_{l}^{n} {l}_{i}$$

where lᵢ=length of the ith fiber and n=number of measured fibers and advantageously shown as a histogram or for an assumed normal distribution of the measured glass fiber lengths l may be determined using the Gaussian function according to the equation

$$f ( l ) = \frac{1}{\sqrt{2 π} \cdot σ} \cdot e \text{?} . \\ \text{?} \text{indicates text missing or illegible when filed}$$

In this equation, l_{c} and σ are specific parameters of the normal distribution: l_{c} is the mean and σ is the standard deviation (see: M. Schoßig, Schädigungsmechanismen in faserverstärkten Kunststoffen, 1, 2011, Vieweg and Teubner Verlag, page 35, ISBN 978-3-8348-1483-8). Glass fibers not incorporated into a polymer matrix are analysed with respect to their lengths by the above methods, but without processing by ashing and separation from the ash.

The glass fibers [CAS No. 65997-17-3] preferably employable as a filler of the component (d) according to the invention preferably have a fiber diameter in the range from 7 to 18 μm, particularly preferably in the range from 9 to 15 μm, which is determinable by at least one facility available to those skilled in the art, in particular determinable by computer x-ray microtomography analogously to “Quantitative Messung von Faserlängen und-verteilung in faserverstärkten Ku nststoffteilen mittels μ-Röntgen-Computertomographie”, J. KASTNER, et al. DGZfP-Jahrestagung 2007-paper 47. The glass fibers preferably employable as component (d) are preferably added in the form of chopped or ground glass fibers.

In one embodiment the fillers and/or reinforcers employable as component (d), in particular glass fibers, are preferably provided with a suitable size system and an adhesion promoter/adhesion promoter system particularly preferably based on silane.

In a further preferred embodiment of the present invention the compositions contain no other components in addition to the components a), b) and c), wherein in this case the proportions of a), b) and c) sum to 100% by weight.

The present invention further provides a process for producing the composition in which the components a) and b) and optionally at least one component (d) are admixed into PBT with the proviso that the PBT is present neither as a block copolymer nor as a copolymer. Preference is given here to extruders or kneaders, particularly preferably extruders. These are commercially available stirring and mixing assemblies.

In one preferred embodiment of the present invention the admixing of the components a), b) and optionally at least one component (d) into the PBT is effected at temperatures in the range from 150° C. to 300° C.

The present invention further relates to a process for producing hydrolysis-stable articles of manufacture by processing compositions containing the components (a), (b), optionally with at least one component (d), and (c) in at least one mixing assembly, preferably a compounder, into molding materials and subjecting these to further processing, preferably an injection molding process or an extrusion, to produce articles of manufacture.

Processes according to the invention for producing articles of manufacture by extrusion or injection molding are performed at melt temperatures in the range from 160 to 330° C., preferably in the range from 190 to 300° C., and optionally also at pressures of not more than 2500 bar, preferably at pressures of not more than 2000 bar, particularly preferably at pressures of not more than 1500 bar and very particularly preferably at pressures of not more than 750 bar. The PBT-based compositions according to the invention feature exceptional melt stability, wherein in the context of the present invention melt stability will be understood by those skilled in the art to mean that even after residence times >5 min at markedly above the melting point of the molding material of >260° C. no increase in the melt viscosity determinable according to ISO 1133 (1997) is observed.

In extrusion it is preferable to distinguish between profile extrusion and sequential coextrusion. Sequential coextrusion involves extruding two different materials successively in an alternating sequence. This forms a preform having a material composition that differs section by section in the extrusion direction. It is possible to provide particular article sections with specifically required properties through appropriate material selection, for example for articles with soft ends and a hard middle section or integrated soft bellows regions (Thielen, Hartwig, Gust, “Blasformen von Kunststoffhohlkörpern” [Blow-molding of Hollow Plastics Bodies], Carl Hanser Verlag, Munich 2006, pages 127-129).

The process of injection molding comprises melting (plastifying) the raw material, preferably in pellet form, in a heated cylindrical cavity, and injection thereof as an injection molding material under pressure into a temperature-controlled cavity. Employed as raw material are compositions according to the invention which have preferably already been processed into a molding material by compounding, where said molding material has in turn preferably been processed into a pellet material. After cooling (solidification) of the molding material injected into the temperature-controlled cavity the injection-molded part is demolded.

In contrast to injection molding, in extrusion an endless plastics extrudate of a molding material according to the invention is employed in an extruder, wherein the extruder is a machine for producing thermoplastic moldings/articles of manufacture. Employable apparatuses include
single-screw extruders and twin-screw extruders and the respective sub-groups
conventional single-screw extruders, conveying single-screw extruders,
contra-rotating twin-screw extruders and co-rotating twin-screw extruders.

Extrusion plants preferably consist of the elements extruder, mold, downstream equipment, extrusion blow molds. Extrusion plants for producing profiles preferably consist of the elements: extruder, profile mold, calibrating unit, cooling zone, caterpillar take-off and roller take-off, separating device and tilting chute. Extrusion plants for producing films consist of the elements: extruder, cooling zone, stretching and roller take-off.

Articles of manufacture obtainable according to the invention are preferably materials exposed to aqueous media, atmospheric humidity or water spray.

According to the invention, articles of manufacture producible from the hydrolysis-stabilized and in particular melt-stable compositions may be found in particular in motor vehicles, in the electronics, telecommunications, information technology or computer industries and also in the household, sports, medical or entertainment sectors. In a preferred variant the compositions according to the invention are used for producing hydrolysis-stable films, for example for packaging or solar cells.

The present invention further provides for the use of the compositions according to the invention for producing articles of manufacture by extrusion, preferably for packaging or solar cells.

The purview of the invention encompasses all hereinabove and hereinbelow recited general or preferred definitions of radicals, indices, parameters and elucidations among themselves, i.e. including between the respective ranges and preferences in any combination.

The examples which follow serve to elucidate the invention but have no limiting effect.

### EXEMPLARY EMBODIMENTS

Materials employed:
1) (a): a polymeric carbodiimide having an NCN content of about 13% by weight obtainable from Lanxess Deutschland GmbH under the name Stabaxol® P100.
2) (b): an epoxide of formula (III) where n=in the range from 2-3 with an epoxide equivalent weight (DIN 16945) of 500 to 700 g/eq and a softening point (Mettler, DIN 51920) between 75° C. and 90° C. [CAS Nr. 25068-38-6].
3) (c): polybutylene terephthalate (PBT) Pocan® B 1300 from Lanxess Deutschland GmbH.
4) further additives such as nucleating agents, flow improvers, demolding agents or stabilizers.

### Hydrolysis Inhibition in Polybutylene Terephthalate (PBT)

To evaluate the hydrolysis-inhibiting effect in PBT the components (a) and (b) to be employed were dispersed into component (c) by means of a ZSK 25 laboratory twin screw extruder from Werner & Pfleiderer before the measurement in PBT at about 260° C. described below. F3 standard test specimens used for measuring tensile strength were then prepared from the obtained pellet materials on an Arburg Allrounder 320 S 150-500 injection molding machine.

For the hydrolysis test, these F3 standard test specimens were stored in water vapor at a temperature of 100° C. and the tensile strength thereof measured in MPa.

The usage amounts of the composition constituents are listed in Table 1:

TABLE 1

| | Ex. 1 PBT |
|---|---|
| (a) | 1 |
| (b) | 2 |
| (c) | 94.14 |
| (d) | 2.86 |
| MVR at 260° C./2.16 kg; 5 min | 53 cm³/10 min |
| MVR at 260° C./2.16 kg; 20 min | 64 cm³/10 min |
| Relative tensile strength (%) after 15 days of | 123 |
| storage at 100° C., 100% atmospheric humidity | |

All reported usage amounts for the components (a) to (d) are in percent by weight.

The results of the hydrolysis inhibition test show the required hydrolysis stability of the inventive PBT-based compositions/the articles of manufacture producible therefrom, the compositions showing a high melt stability during processing.

1-12. (canceled)

13. A composition containing
(a) at least one polymeric aromatic carbodiimide of formula (I)
R¹-R²—(—N═C═N—R²—)ₘ—R¹ (I),
in which
m represents an integer from 2 to 500,
R² is C₁-C₁₂-alkyl-substituted arylenes, C₇-C₁₅-alkylaryl-substituted arylenes and optionally C₁-C₁₂-alkyl-substituted alkylene-bridged arylenes comprising a total of 7 to 30 carbon atoms and arylene
and
R¹ is —NCO, —NCNR³, —NHCONHR³, —NHCONR³R⁴ or —NHCOOR⁵,
wherein R³ and R⁴ are identical or different and represent a C₁-C₁₂-alkyl, C₆-C₁₂-cycloalkyl, C₇-C₁₅-aralkyl or aryl radical and R⁵ represents a C₁-C₂₂-alkyl, C₆-C₁₂-cycloalkyl, C₆-C₁₅-aryl or C₇-C₁₅-aralkyl radical and an unsaturated alkyl radical having 2-22 carbon atoms or an alkoxypolyoxyalkylene radical,
(b) at least one epoxide, and
(c) at least one thermoplastic polyester-based polymer selected from the group of polyethylene terephthalate, polybutylene terephthalate, polytrimethylene terephthalate, thermoplastic polyester elastomers, ethylene vinyl acetate, polylactic acid and/or PLA derivatives, polybutylene succinates, polyhydroxyalkanoates and various blends, thermoplastic polyurethanes, polyurethane elastomers, PU adhesives and PU casting resins.

14. The composition according to claim 13, wherein m represents an integer from 3 to 20.

15. The composition according to claim 13, wherein m represents an integer from 4 to 10.

16. The composition as claimed in claim 13, wherein components a), b) and c) are present in the following proportions:
a) 0.2-2% by weight,
b) 0.05-4% by weight,
c) 94-99.75% by weight.

17. The composition as claimed in claim 13, wherein components a), b) and c) are present in the following proportions:
a) 0.4-1.5% by weight,
b) 0.1-2% by weight,
c) 96.5-99.5% by weight.

18. The composition as claimed in claim 13, wherein components a), b) and c) are present in the following proportions:
a) 0.5-1.0% by weight,
b) 0.5-1.5% by weight,
c) 97.5-99.0% by weight.

19. The composition as claimed in claim 13, wherein the polymeric aromatic carbodiimides are compounds of formula (II) 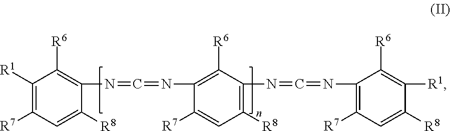
where R¹ is selected from the group of —NCO, —NHCONHR³, —NHCONR³R⁴ and —NHCOOR⁵,
wherein R³ and R⁴ are identical or different and represent a C₁-C₁₂-alkyl, C₆-C₁₂-cycloalkyl, C₇-C₁₈-aralkyl radical or aryl radical,
R⁵ represents a C₁-C₂₂-alkyl, C₆-C₁₂-cycloalkyl, C₆-C₁₈-aryl or C₇-C₁₈-aralkyl radical and an unsaturated alkyl radical having 2-22 carbon atoms, or an alkoxypolyoxyalkylene radical and,
R⁶, R⁷ and R⁸ each independently represent methyl or ethyl, wherein each benzene ring bears only one methyl group and n=1 to 10.

20. The composition as claimed in claim 13, wherein the polymeric aromatic carbodiimides are compounds of formula (II) 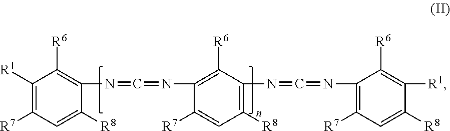
where R¹ is selected from the group of —NCO, —NHCONHR³, —NHCONR³R⁴ and —NHCOOR⁵,
wherein R³ and R⁴ are identical or different and represent a C₁-C₁₂-alkyl, C₆-C₁₂-cycloalkyl, C₇-C₁₈-aralkyl radical or aryl radical,
R⁵ represents a C₁-C₂₂-alkyl, C₆-C₁₂-cycloalkyl, C₆-C₁₈-aryl or C₇-C₁₈-aralkyl radical and an unsaturated alkyl radical having 12-20 carbon atoms, or an alkoxypolyoxyalkylene radical and,
R⁶, R⁷ and R⁸ each independently represent methyl or ethyl, wherein each benzene ring bears only one methyl group and n=1 to 10.

21. The composition as claimed in claim 13, wherein the polymeric aromatic carbodiimides are compounds of formula (II) 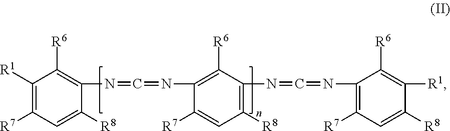
where R¹ is selected from the group of —NCO, —NHCONHR³, —NHCONR³R⁴ and —NHCOOR⁵,
wherein R³ and R⁴ are identical or different and represent a C₁-C₁₂-alkyl, C₆-C₁₂-cycloalkyl, C₇-C₁₈-aralkyl radical or aryl radical,
R⁵ represents a C₁-C₂₂-alkyl, C₆-C₁₂-cycloalkyl, C₆-C₁₈-aryl or C₇-C₁₈-aralkyl radical and an unsaturated alkyl radical having 16-18 carbon atoms, or an alkoxypolyoxyalkylene radical and,
R⁶, R⁷ and R⁸ each independently represent methyl or ethyl, wherein each benzene ring bears only one methyl group and n=1 to 10.

22. The composition as claimed in claim 13, wherein the epoxide is an epoxide having at least 2 epoxide groups.

23. The composition as claimed in claim 22, wherein the epoxide is an oligomeric reaction product of bisphenol A with epichlorohydrin having an average molecular weight according to EN ISO 10927 in the range from 900 to 1200 g/mol and an epoxy index (according to ISO 3001) in the range from 450 to 600 grams per equivalent.

24. The composition as claimed in claim 22, wherein the epoxide is an oligomeric reaction product of bisphenol A with epichlorohydrin
of formula (III) 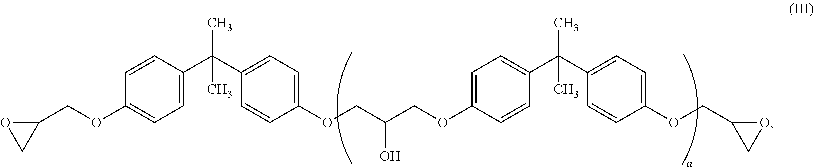
where a is 0 to 10 and represents the average number.

25. The composition according to claim 24, wherein a is 1 to 8 and represents the average number.

26. The composition according to claim 24, wherein a is 1 to 6 and represents the average number.

27. The composition according to claim 24, wherein a is from 2 to 3 and represents the average number.

28. The composition as claimed in claim 22, wherein the epoxide is a compound containing the units 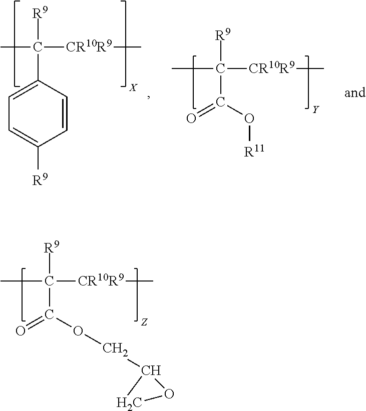
where R⁹, R¹⁰ represent independently of one another H, C₁-C₈-alkyl, R¹¹ represent independently of one another C₁-C₈-alkyl, x, y=1-20, z is 2-20, and wherein end groups R* are H, C₁-C₈-alkyl, in any sequence.

29. The composition as claimed in claim 22, wherein the epoxide is a compound of formula (IV) 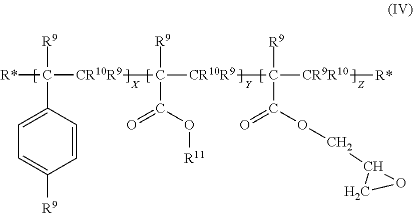
R⁹, R¹⁰═H, C₁-C₈-alkyl, R¹⁹═C₁-C₈-alkyl, x, y=1-20 and z=2-20,
and R*═H, C₁-C₈-alkyl.

30. A process for producing a composition as claimed in claim 13, comprising admixing the components a), b) into the at least one thermoplastic polyester-based polymer c).

31. The process for producing a composition as claimed in claim 30, the admixing is performed at temperatures of 160-330° C.

32. An article of manufacture, obtainable by admixing the composition as claimed in claim 13 in at least one mixing assembly, and further processing to provide molding materials in injection molding processes or by extrusion.
